(19) United States
(12) Patent Application Publication
(10) Pub. No.: US 2024/0288460 A1
(43) Pub. Date: Aug. 29, 2024

(54) LABORATORY SAMPLE CONTAINER CARRIER HANDLING APPARATUS, LABORATORY AUTOMATION SYSTEM, AND USE

(71) Applicant: Roche Diagnostics Operations, Inc., Indianapolis, IN (US)

(72) Inventors: Yöran Dokuzluoglu, Basel (CH); Lotar Schenk, Knonau (CH); Thomas Sidler, Hunenberg (CH); Avinash Addihalli Narayana, Stuttgart (DE); Tobias Huber, Backnang (DE)

(73) Assignee: Roche Diagnostics Operations, Inc., Indianapolis, IN (US)

(21) Appl. No.: 18/656,996

(22) Filed: May 7, 2024

Related U.S. Application Data
(63) Continuation of application No. PCT/EP2022/085588, filed on Dec. 13, 2022.

(30) Foreign Application Priority Data
Dec. 15, 2021 (EP) 21214668.2

(51) Int. Cl. G01N 35/04

(52) U.S. Cl. CPC G01N 35/04; G01N 2035/0441; G01N 2035/0477

(57) ABSTRACT

The invention relates to a laboratory sample container carrier handling apparatus comprising a revolving device and a guiding surface, wherein an entry segment of the guiding surface is adapted to smoothly receive a laboratory sample container carrier. The invention further relates to a laboratory automation system comprising such a laboratory sample container carrier handling apparatus and to a use of such a laboratory sample container carrier handling apparatus for handling a laboratory sample container carrier in, in particular such, a laboratory automation system.

### TECHNICAL FIELD

The invention relates to a laboratory sample container carrier handling apparatus, to a laboratory automation system comprising such a laboratory sample container carrier handling apparatus, and to a use of such a laboratory sample container carrier handling apparatus for handling a laboratory sample container carrier in, in particular such, a laboratory automation system.

EP 3 196 654 A1 discloses a method and a device for transferring sample tubes between a laboratory automation system and a sample archiving system, wherein for transferring a sample tube from the laboratory automation system to the sample archiving system, a sample tube carrier carrying at least one sample tube is conveyed to a first take-over module via a first conveyor line, at the first take-over module the at least one sample tube is removed from the sample tube carrier, and the empty sample tube carrier is conveyed away from the first take-over module via a second conveyor line, and for transferring a sample tube from the sample archiving system to the laboratory automation system, an empty sample tube carrier is conveyed to a second take-over module via a third conveyor line, at the second take-over module at least one sample tube is inserted into the sample tube carrier, and the sample tube carrier carrying the at least one sample tube is conveyed away from the second take-over module via a fourth conveyor line.

### SUMMARY OF THE INVENTION

It is an object of the invention to provide for a laboratory sample container carrier handling apparatus comprising improved properties, in particular enabling a reduction or prevention of problems. It is a further object of the invention to provide for a laboratory automation system comprising such a laboratory sample container carrier handling apparatus, and to provide for a use of such a laboratory sample container carrier handling apparatus for handling a laboratory sample container carrier in, in particular such, a laboratory automation system.

This object is solved by a laboratory sample container carrier handling apparatus, a laboratory automation system, and a use with the features of the respective independent claims. Preferred embodiments are defined in the dependent claims.

The invention relates to a laboratory sample container carrier handling apparatus. In particular the laboratory sample container carrier handling apparatus may be adapted to be coupled to a laboratory sample distribution system, in particular allowing different or variable, respectively, entry positions of a laboratory sample container carrier carrying a, in particular open, laboratory sample container containing a laboratory sample. The laboratory sample container carrier handling apparatus comprises a revolving device and a, in particular lateral, guiding surface or wall, respectively. The guiding surface comprise an open ring shape, in particular only, partially surrounding the revolving device circumferentially or laterally or outside, respectively. In particular the guiding surface may be adapted to guide the laboratory sample container carrier. The revolving device is adapted to push or move, respectively, the laboratory sample container carrier, in particular while, supplied to the revolving device from an entry position, in particular of different allowed entry positions, to an exit position, in particular partially, along or in contact with, respectively, the guiding surface in a circumferential direction. The guiding surface comprises an entry segment. The entry segment comprises, in particular only, a non-convex shape. A distance, in particular a value of the distance, of the entry segment from a center of the revolving device is greater at a start, in particular point, of the entry segment than at an end, in particular point, of the entry segment in the circumferential direction.

This enables a movement of the laboratory sample container carrier, in particular from different allowed entry positions, in contact with the guiding surface under a small or even no angle or, in particular essentially, tangential or flat, respectively, in particular in contrast to an entry segment comprising a convex shape and/or a constant distance. Thus, this enables a smooth or gentle, respectively, entry of the laboratory sample container carrier or with a small or even no impact, respectively. Thus, this enables a reduction or prevention of a risk of, in particular inadvertent, spillage of the laboratory sample out of the, in particular open, laboratory sample container. Thus, this enables a reduction or prevention of a risk of, in particular inadvertent, cross-contamination.

In particular the laboratory sample container carrier handling apparatus may be denoted as carousel.

The laboratory sample container may be open at its top. Additionally or alternatively the term “uncapped” may be used synonymously for the term “open”. Additionally or alternatively the laboratory sample container may be a tube.

The laboratory sample may be a, in particular body, liquid or fluid, respectively, in particular a blood sample.

The revolving device may be motor-driven. Additionally or alternatively the term “star rotator” or “star wheel” may be used synonymously for the term “revolving device”. Additionally or alternatively the revolving device may comprise a pushing element enclosing a rotating pushing area with the guiding surface. The pushing area may be adapted to push the laboratory sample container carrier supplied to the revolving device from the entry position to the exit position. In particular, the pushing area may increase, in particular continuously, to finally form-fit with a footprint of the laboratory sample container carrier. In particular to form-fit may mean to fit with a tolerance of less than 5 mm (Millimeter), in particular 1 mm, in particular less than 1 mm. Additionally or alternatively the revolving device may comprise a number (e.g. between 5 and 20) of pushing cavities being adapted to receive the laboratory sample container carrier to be rotated and to push the received laboratory sample container carrier. Thus, each laboratory sample container carrier may have its own cavity. In particular a respective pushing cavity may comprise two side walls, wherein the side walls may rotate around the center or an axis of rotation, respectively, of the revolving device, wherein a side wall may push the laboratory sample container carrier being in contact with the side wall. In particular the side walls may contact each other along the axis of rotation of the revolving device. This may be regarded with respect to actually visible side walls, or also with respect to lines that may be used in order to define dimensions of the cavities.

The guiding surface or its open ring shape, respectively, may surround the revolving device in a radial direction, in particular non-parallel, in particular orthogonal, to the circumferential direction. Additionally or alternatively the guiding surface may be continuous in the circumferential direction. Additionally or alternatively the term “guiding arch” may be used synonymously for the term “guiding surface”.

The term/s “has/have” may be used synonymously for the term/s “comprise/s”.

The term “form” may be used synonymously for the term “shape”.

The term “encompass” may be used synonymously for the term “surround”.

The term “configured” may be used synonymously for the term “adapted”.

The term “start” may be used synonymously for the term “entry”.

The contact may be a direct and/or a physical contact. Additionally or alternatively the term “touch” may be used synonymously for the term “contact”.

The entry position may be a position at which the laboratory sample container carrier may be received by the laboratory sample container carrier handling apparatus, in particular the revolving device. Additionally or alternatively the exit position may be a position at which the laboratory sample container carrier may be transferred by the laboratory sample container carrier handling apparatus, in particular the revolving device.

The revolving device and/or the guiding surface may be adapted such that, in particular the, one laboratory sample container carrier may be at the entry position or enter the revolving device and/or the guiding surface, respectively, and another one laboratory sample container carrier may be at the exit position or exit the revolving device and/or the guiding surface, respectively, at the same time or simultaneously, respectively.

The entry segment surrounds the revolving device in an angle range between 40° and 700 in the circumferential direction around the center of the revolving device. This/these value/s enable/s the movement of the laboratory sample container carrier, in particular from different allowed entry positions, in contact with the guiding surface under a very small or even no angle. Thus, this enables a very smooth entry of the laboratory sample container carrier or with a very small or even no impact, respectively. In particular the range may comprise its limit values.

According to an embodiment of the invention, the laboratory sample container carrier handling apparatus is adapted to be coupled to a, in particular bottom, transport plane of a, in particular the, laboratory sample distribution system, in particular being adapted to support the laboratory sample container carrier. The laboratory sample container carrier handling apparatus comprises a, in particular bottom, driving surface, in particular being adapted to support the laboratory sample container carrier. The revolving device is adapted to push the laboratory sample container carrier on top of or in contact with, respectively, the driving surface, in particular and on top of the transport plane at the entry position and/or at the exit position. In particular the revolving device and/or the driving surface may be adapted such that the transport plane partially may extend under or below, respectively, the revolving device. In other words: the revolving device partially may rotate over the transport plane. Additionally or alternatively the driving surface may be adapted such that the transport plane may be adjacent to the driving surface. Additionally or alternatively the driving surface may start at the entry position and/or end at the exit position. Additionally or alternatively the entry position may be a position at which the laboratory sample container carrier may be received from the transport plane. Additionally or alternatively the exit position may be a position at which the laboratory sample container carrier may be transferred to the transport plane. Additionally or alternatively the driving surface may be stationary, in particular arranged and/or to the transport plane.

According to an embodiment of the invention, the guiding surface comprises an at least middle segment. The at least middle segment is, in particular directly, adjacent to the entry segment in the circumferential direction and comprises a circular shape. In particular a distance, in particular a value of the distance, of the at least middle segment from the center of the revolving device is constant in the circumferential direction. Additionally or alternatively the distance of the entry segment from the center of the revolving device is equal at the end of the entry segment to the distance of the at least middle segment from the center of the revolving device at least at the entry segment. This enables a smooth transition of the laboratory sample container carrier from the entry segment to the at least middle segment. In particular the entry segment and the at least middle segment may smoothly transition into each other. Additionally or alternatively the guiding surface or the at least middle segment may comprise an exit segment. The exit segment may be, in particular directly, adjacent to the middle segment in the circumferential direction.

According to an embodiment of the invention, the guiding surface comprises at least a first portion, in particular directly, adjacent to the at least middle segment. A radius, in particular a value of the radius, of the first portion is greater than a radius, in particular a value of the radius, of the at least middle segment at least at the entry segment. This enables the movement of the laboratory sample container carrier, in particular from different allowed entry positions, in contact with the guiding surface under a very small or even no angle. Thus, this enables a very smooth entry of the laboratory sample container carrier or with a very small or even no impact, respectively. In particular the term “part” may be used synonymously for the term “portion”.

According to an embodiment of the invention, the guiding surface comprises a, in particular the, first portion and a second portion, in particular directly, adjacent to the first portion against the circumferential direction. A, in particular the, radius, in particular a value of the radius, of the first portion, in particular the radius of the at least middle segment at least at the entry segment, is greater than a radius of the second portion. This enables the movement of the laboratory sample container carrier, in particular from different allowed entry positions, in contact with the guiding surface under a very small or even no angle. Thus, this enables a very smooth entry of the laboratory sample container carrier or with a very small or even no impact, respectively. In particular the first portion and the second portion may smoothly transition into each other.

According to an embodiment of the invention, the guiding surface comprises a third portion, in particular directly, adjacent to the second portion against the circumferential direction. The radius of the second portion is greater than a radius, in particular a value of the radius, of the third portion. In particular the second portion and the third portion may smoothly transition into each other.

The radius may be adapted such that it becomes greater or increases, respectively, in particular continuously, along the entry segment in the circumferential direction.

According to an embodiment of the invention, the radius of the first portion is in a range between 150 mm and 190 mm and/or between 7.5 times and 9.5 times the radius of a, in particular the, pushing cavity or compartment, respectively, of the revolving device. The pushing cavity is adapted to receive the laboratory sample container carrier to be rotated and to push the received laboratory sample container carrier. Additionally or alternatively the radius of the second portion is in a range between 40 mm and 60 mm and/or between 2 times and 3 times the radius of the pushing cavity. Additionally or alternatively the radius of the third portion is in a range between 40 mm and 50 mm and/or between 2 times and 2.5 times the radius of the pushing cavity. Additionally or alternatively the radius of the at least middle segment at least at the entry segment is in a range between 50 mm and 70 mm and/or between 2.5 times and 3.5 times the radius of the pushing cavity. This/these value/s enable/s the movement of the laboratory sample container carrier, in particular from different allowed entry positions, in contact with the guiding surface under a very small or even no angle. Thus, this enables a very smooth entry of the laboratory sample container carrier or with a very small or even no impact, respectively. In particular the range may comprise its limit values. Additionally or alternatively the pushing cavity may comprise a shape form-fitting or corresponding, in particular partially, respectively, to a shape or a cross-section or an outer circumference, respectively, of the laboratory sample container carrier.

According to an embodiment of the invention, the guiding surface surrounds the revolving device in an angle range between 2050 (degree) and 290° in the circumferential direction around the center of the revolving device. Additionally or alternatively the at least middle segment surrounds the revolving device in an angle range between 165° and 220° in the circumferential direction around the center of the revolving device. This/these value/s enable/s the movement of the laboratory sample container carrier, in particular from different allowed entry positions, in contact with the guiding surface under a very small or even no angle. Thus, this enables a very smooth entry of the laboratory sample container carrier or with a very small or even no impact, respectively. In particular the range may comprise its limit values.

According to an embodiment of the invention, the guiding surface, the entry segment and/or the at least middle segment are/is, in particular only, continuously in the circumferential direction and/or comprise/s, in particular only, a concave shape. Additionally or alternatively the entry segment comprises a shape between an ellipse and a rounded rectangle. In particular the entry segment does not have to or may not comprise a circular shape.

The invention relates further to a laboratory automation system. The laboratory automation system comprises a, in particular the, laboratory sample distribution system, in particular allowing different entry positions of a laboratory sample container carrier carrying a, in particular open, laboratory sample container containing a laboratory sample. The laboratory automation system comprises the laboratory sample container carrier handling apparatus as described above. The laboratory sample container carrier handling apparatus is coupled to the laboratory sample distribution system. In particular the laboratory automation system comprises the laboratory sample container carrier. This enables a smooth handling of the laboratory sample container carrier. In particular the laboratory sample container carrier may comprise a round, in particular circular, shape or cross-section, respectively, in particular where in contact with the revolving device and/or the guiding surface and/or in top view. Additionally or alternatively the laboratory sample container carrier may be adapted to carry, in particular only, one or more laboratory sample containers. Additionally or alternatively the laboratory sample container carrier may be adapted as disclosed in EP 2 908 139 A2 or EP 3 456 415 A1 or similar to those laboratory sample container carriers. Additionally or alternatively the laboratory sample distribution system may be adapted as disclosed in EP 2 773 968 B1. Reference is insofar made to the relevant technical literature.

According to an embodiment of the invention, the laboratory automation system comprises the laboratory sample container carrier handling apparatus as described above with respect to coupling to the transport plane. The laboratory sample distribution system comprises the transport plane, in particular being adapted to support the laboratory sample container carrier. The laboratory sample container carrier handling apparatus is coupled to the transport plane. In particular the transport plane may be adjacent to the driving surface. Additionally or alternatively the transport plane and the driving surface may smoothly transition into each other. Additionally or alternatively the transport plane and the driving surface may be identical to each other. Additionally or alternatively the transport plane may be adapted as disclosed in EP 2 773 968 B1. Reference is insofar made to the relevant technical literature.

According to an embodiment of the invention, the laboratory sample distribution system comprises drive means. The drive means are adapted to move the laboratory sample container carrier on top of or in contact with, respectively, the transport plane. The transport plane is, in particular directly, adjacent to the driving surface. The drive means are adapted to supply the laboratory sample container carrier to the revolving device and/or to receive the laboratory sample container carrier from the revolving device. This enables an efficient exchange of the laboratory sample container carrier between the transport plane and the revolving device. In particular the drive means may be adapted as disclosed in EP 2 773 968 B1. Reference is insofar made to the relevant technical literature.

According to an embodiment of the invention, the laboratory sample container carrier comprises at least one magnetically active device, in particular at least one permanent magnet. The drive means comprise a number of electro-magnetic actuators being stationary arranged in rows and columns below the transport plane. The electro-magnetic actuators are adapted to apply a magnetic force to the laboratory sample container carrier. This enables a smooth and flexible driving of the laboratory sample container carrier.

According to an embodiment of the invention, the laboratory automation system comprises at least one pre-analytical, analytical and/or post-analytical laboratory apparatus. The laboratory apparatus is adapted to interact with the laboratory sample container carrier, a, in particular open, laboratory sample container carried by the laboratory sample container carrier, and/or a laboratory sample contained by the laboratory sample container, in particular, while, supplied to the revolving device. In particular the laboratory apparatus may be a supervising device, in particular a camera, a recapping device, and/or an identification device, in particular a barcode reader. Additionally or alternatively the laboratory apparatus may be at the at least middle segment, in particular in the circumferential direction.

The invention relates further to a use of the laboratory sample container handling apparatus as described above for handling, in particular revolving, the laboratory sample container carrier, in particular carrying the, in particular open, laboratory sample container containing the laboratory sample, in a, in particular the, laboratory automation system, in particular as described above.

### BRIEF DESCRIPTION OF THE DRAWINGS

In the following, embodiments of the invention will be described in detail with reference to the drawings. Throughout the drawings, the same elements will be denoted by the same reference numerals.

FIG. 1 schematically depicts a top view of a laboratory automation system according to the invention,

FIG. 2 schematically depicts a cross-sectional side view of a laboratory sample container carrier comprised by the laboratory automation system,

FIG. 3 schematically depicts a perspective view of a laboratory sample container carrier handling apparatus according to the invention comprised by the laboratory automation system,

FIG. 4 schematically depicts a perspective view of a guiding surface of the laboratory sample container carrier handling apparatus of FIG. 3,

FIG. 5 schematically depicts a top view of the guiding surface of FIG. 4, and

FIG. 6 schematically depicts another top view of the laboratory automation system.

### DETAILED DESCRIPTION OF EMBODIMENTS OF THE INVENTION

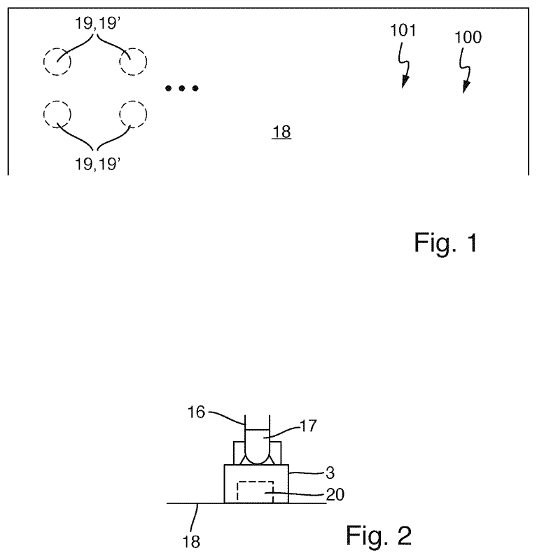

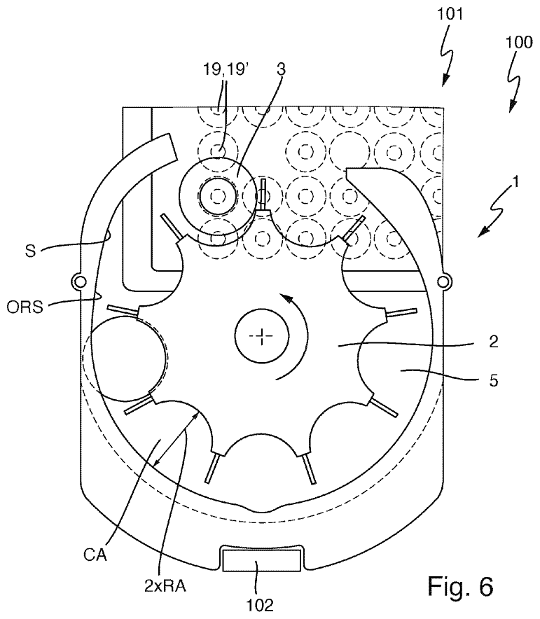

FIG. 1 schematically depicts a top view of a laboratory automation system 100 according to the invention. The laboratory automation system 100 comprises a plurality of laboratory sample container carriers 3, one of which is schematically depicted in FIGS. 2 and 6.

Each laboratory sample container carrier 3 is adapted to carry, in particular carries, one laboratory sample container 16. The laboratory sample container 16 comprises a laboratory sample 17 to be analyzed.

The laboratory automation system 100 further comprises a laboratory sample distribution system 101, which is schematically depicted in FIGS. 1 and 6.

The laboratory sample distribution system 101 comprises a, in particular flat, transport plane 18. The transport plane 18 is adapted to support, in particular supports, the laboratory sample container carriers 3. In other words: the laboratory sample container carriers 3 are placed on top of the transport plane 18.

The laboratory sample distribution system 100 further comprises drive means 19. The drive means 19 are adapted to move, in particular move, the laboratory sample container carrier 3 on top of the transport plane 18.

In detail the laboratory sample container carrier 3 comprises at least one magnetically active device 20, in particular at least one permanent magnet, in particular in a bottom portion of the laboratory sample container carrier 3, which is schematically depicted in FIG. 2. The drive means 19 comprise a number of electro-magnetic actuators 19′ being stationary arranged in rows and columns below the transport plane 18. The electro-magnetic actuators 19′ are adapted to apply, in particular apply, a magnetic force to the laboratory sample container carrier 3. Thus, the electro-magnetic actuators 19′ are adapted to move, in particular move, the sample container carrier 3.

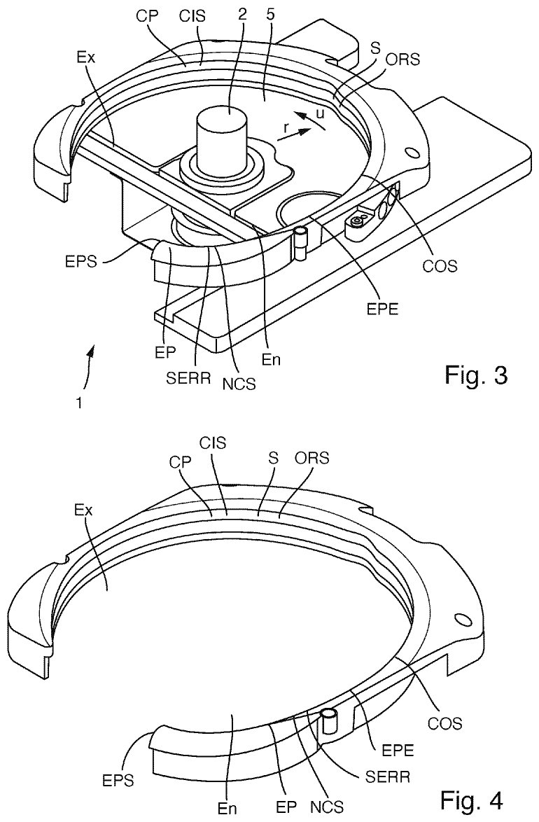

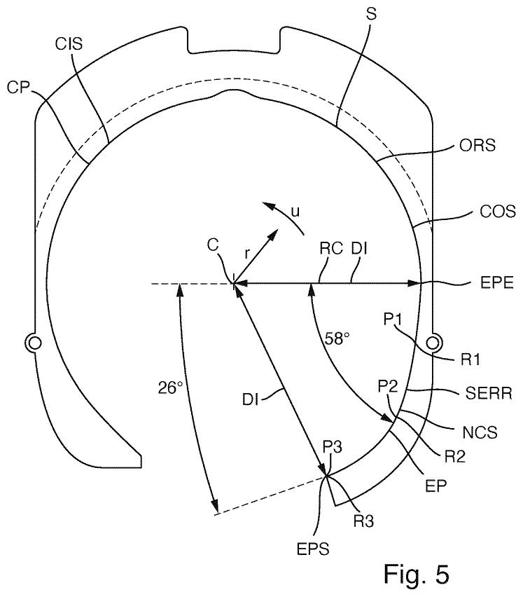

The laboratory sample distribution system 100 further comprises a laboratory sample container carrier handling apparatus 1 according to the invention, which is schematically depicted in FIGS. 3 and 6. The laboratory sample container carrier handling apparatus 1 comprises a revolving device 2, wherein in FIG. 3 only a part of the revolving device 2 is depicted. The laboratory sample container carrier handling apparatus 1 further comprises a guiding surface S, which is depicted in FIG. 3 to 6. The guiding surface S comprises an open ring shape ORS partially surrounding the revolving device 2 circumferentially. The revolving device 2 is adapted to push, in particular pushes, the laboratory sample container carrier 3 supplied to the revolving device 2 from an entry position En to an exit position Ex along the guiding surface S in a circumferential direction u. The guiding surface S comprises an entry segment EP. The entry segment EP comprises a non-convex shape NCS. A distance DI of the entry segment EP from a center C of the revolving device 2 is greater at a start EPS of the entry segment EP than at an end EPE of the entry segment EP in the circumferential direction u.

In detail the laboratory sample container carrier handling apparatus 1 is adapted to be coupled, in particular is coupled, to the laboratory sample distribution system 101, in particular its transport plane 18.

The laboratory sample container carrier handling apparatus 1 comprises a driving surface 5. The revolving device 2 is adapted to push, in particular pushes, the laboratory sample container carrier 3 on top of the driving surface 5, in particular and on top of the transport plane 18 at the entry position En and/or at the exit position Ex.

The transport plane 18 is adjacent to the driving surface 5. The drive means 19 are adapted to supply, in particular supply, the laboratory sample container carrier 3 to the revolving device 2 and/or to receive, in particular receive, the laboratory sample container carrier 3 from the revolving device 2.

The guiding surface S comprises an at least middle segment CP. The at least middle segment CP is adjacent to the entry segment EP in the circumferential direction u and comprises a circular shape CIS.

In particular a distance DI of the at least middle segment CP from the center C of the revolving device 2 is constant in the circumferential direction u.

Additionally or alternatively the distance DI of the entry segment EP from the center C of the revolving device 2 is equal at the end EPE of the entry segment EP to the distance DI of the at least middle segment CP from the center C of the revolving device 2 at least at the entry segment EP.

The guiding surface S comprises at least a first portion P1.

The first portion P1 is adjacent to the at least middle segment CP. A radius R1 of the first portion P1 is greater than a radius RC of the at least middle segment CP at least at the entry segment EP.

The guiding surface S comprises a second portion P2 adjacent to the first portion P1 against the circumferential direction u. The radius R1 of the first portion P1, in particular the radius RC of the at least middle segment CP at least at the entry segment EP, is greater than a radius R2 of the second portion P2.

The guiding surface S comprises a third portion P3 adjacent to the second portion P2 against the circumferential direction u. The radius R2 of the second portion P2 is greater than a radius R3 of the third portion P3.

In detail the radius R1 of the first portion P1 is in a range between 150 mm and 190 mm, in particular 170 mm, and/or between 7.5 times and 9.5 times, in particular 8.5 times, the radius RA of a pushing cavity CA of the revolving device 2. The pushing cavity CA is adapted to receive, in particular receives, the laboratory sample container carrier 3 to be rotated and to push, in particular pushes, the received laboratory sample container carrier 3. In particular the revolving device 2 comprises 8 pushing cavities CA. Additionally or alternatively the pushing cavity comprises a semi-circular shape.

Additionally or alternatively the radius R2 of the second portion P2 is in a range between 40 mm and 60 mm, in particular 50 mm, and/or between 2 times and 3 times, in particular 2.5 times, the radius RA of the pushing cavity CA.

Additionally or alternatively the radius R3 of the third portion P3 is in a range between 40 mm and 50 mm, in particular 45 mm, and/or between 2 times and 2.5 times, in particular 2.25 times, the radius RA of the pushing cavity CA.

Additionally or alternatively the radius RC of the at least middle segment CP at least at the entry segment EP is in a range between 50 mm and 70 mm, in particular 60 mm, and/or between 2.5 times and 3.5 times, in particular 3 times, the radius RA of the pushing cavity CA.

The guiding surface S surrounds the revolving device 2 in an angle range between 205° and 290°, in particular of 247.5°, in the circumferential direction u around the center C of the revolving device.

Additionally the entry segment EP surrounds the revolving device 2 in an angle range between 40° and 70°, in particular of 55°, in the circumferential direction u around the center C of the revolving device 2.

Additionally or alternatively the at least middle segment CP surrounds the revolving device 2 in an angle range between 1650 and 220°, in particular of 192.5°, in the circumferential direction u around the center C of the revolving device 2.

The guiding surface S, the entry segment EP and/or the at least middle segment CP are/is, in particular only, continuously in the circumferential direction u and/or comprise/s, in particular only, a concave shape COS.

Additionally or alternatively the entry segment EP comprises a shape SERR between an ellipse and a rounded rectangle.

The laboratory automation system 100 further comprises at least one pre-analytical, analytical and/or post-analytical laboratory apparatus 102, which is schematically depicted in FIG. 6. The laboratory apparatus 102 is adapted to interact, in particular interacts, with the laboratory sample container carrier 3, the laboratory sample container 16 carried by the laboratory sample container carrier 3, and/or the laboratory sample 17 contained by the laboratory sample container 16 supplied to the revolving device 2.

The laboratory sample container handling apparatus 1 is used for handling, in particular revolving, the laboratory sample container carrier 3 in the laboratory automation system 100.

1. Laboratory sample container carrier handling apparatus comprising:
a revolving device, and
a guiding surface,
wherein the guiding surface comprises an open ring shape partially surrounding the revolving device circumferentially,
wherein the revolving device is adapted to push a laboratory sample container carrier supplied to the revolving device from an entry position to an exit position along the guiding surface in a circumferential direction, and
wherein the guiding surface comprises an entry segment, wherein the entry segment comprises a non-convex shape, and wherein a distance of the entry segment from a center of the revolving device is greater at a start of the entry segment than at an end of the entry segment in the circumferential direction,
characterised in that the entry segment surrounds the revolving device in an angle range between 40° and 70° in the circumferential direction around the center of the revolving device.

2. Laboratory sample container carrier handling apparatus according to claim 1,
wherein the laboratory sample container carrier handling apparatus is adapted to be coupled to a transport plane of a laboratory sample distribution system,
wherein the laboratory sample container carrier handling apparatus comprises a driving surface, and
wherein the revolving device is adapted to push the laboratory sample container carrier on top of the driving surface, in particular and on top of the transport plane at the entry position and/or at the exit position.

3. Laboratory sample container carrier handling apparatus according to claim 1,
wherein the guiding surface comprises an at least middle segment, wherein the at least middle segment is adjacent to the entry segment in the circumferential direction and comprises a circular shape,
in particular wherein a distance of the at least middle segment from the center of the revolving device is constant in the circumferential direction, and/or
in particular wherein the distance of the entry segment from the center of the revolving device is equal at the end of the entry segment to the distance of the at least middle segment from the center of the revolving device at least at the entry segment.

4. Laboratory sample container carrier handling apparatus according to claim 3,
wherein the guiding surface comprises at least a first portion adjacent to the at least middle segment, wherein a radius of the first portion is greater than a radius of the at least middle segment at least at the entry segment.

5. Laboratory sample container carrier handling apparatus according to claim 1,
wherein the guiding surface comprises a first portion and a second portion adjacent to the first portion against the circumferential direction,
wherein a radius of the first portion is greater than a radius of the second portion.

6. Laboratory sample container carrier handling apparatus according to claim 5,
wherein the guiding surface comprises a third portion adjacent to the second portion against the circumferential direction,
wherein the radius of the second portion is greater than a radius of the third portion.

7. Laboratory sample container carrier handling apparatus according to claim 4,
wherein the radius of the first portion is in a range between 150 mm and 190 mm and/or between 7.5 times and 9.5 times the radius of a pushing cavity of the revolving device,
wherein the pushing cavity is adapted to receive the laboratory sample container carrier to be rotated and to push the received laboratory sample container carrier, and/or
wherein the radius of the second portion is in a range between 40 mm and 60 mm and/or between 2 times and 3 times the radius of the pushing cavity, and/or
wherein the radius of the third portion is in a range between 40 mm and 50 mm and/or between 2 times and 2.5 times the radius of the pushing cavity, and/or
wherein the radius of the at least middle segment at least at the entry segment is in a range between 50 mm and 70 mm and/or between 2.5 times and 3.5 times the radius of the pushing cavity.

8. Laboratory sample container carrier handling apparatus according to claim 1,
wherein the guiding surface surrounds the revolving device in an angle range between 2050 and 290° in the circumferential direction around the center of the revolving device.

9. Laboratory sample container carrier handling apparatus according to claim 1,
wherein the guiding surface and/or the entry segment are/is continuously in the circumferential direction and/or comprise/s a concave shape.

10. Laboratory automation system, wherein the laboratory automation system comprises:
a laboratory sample distribution system, and
a laboratory sample container carrier handling apparatus according to claim 1, wherein the laboratory sample container carrier handling apparatus is coupled to the laboratory sample distribution system,
wherein the laboratory sample container carrier handling apparatus comprises:
a revolving device, and
a guiding surface,
wherein the guiding surface comprises an open ring shape partially surrounding the revolving device circumferentially,
wherein the revolving device is adapted to push a laboratory sample container carrier supplied to the revolving device from an entry position to an exit position along the guiding surface in a circumferential direction, and
wherein the guiding surface comprises an entry segment, wherein the entry segment comprises a non-convex shape, and wherein a distance of the entry segment from a center of the revolving device is greater at a start of the entry segment than at an end of the entry segment in the circumferential direction,
characterised in that the entry segment surrounds the revolving device in an angle range between 40° and 70° in the circumferential direction around the center of the revolving device.

11. Laboratory automation system according to claim 10, wherein the laboratory sample container carrier handling apparatus is adapted to be coupled to a transport plane of a laboratory sample distribution system,
wherein the laboratory sample container carrier handling apparatus comprises a driving surface, and
wherein the revolving device is adapted to push the laboratory sample container carrier on top of the driving surface, in particular and on top of the transport plane at the entry position and/or at the exit position, and
the laboratory sample distribution system comprises the transport plane,
wherein the laboratory sample container carrier handling apparatus is coupled to the transport plane.

12. Laboratory automation system according to claim 11,
wherein the laboratory sample distribution system comprises drive means, wherein the drive means are adapted to move the laboratory sample container carrier on top of the transport plane,
in particular wherein the transport plane is adjacent to the driving surface, wherein the drive means are adapted to supply the laboratory sample container carrier to the revolving device and/or to receive the laboratory sample container carrier from the revolving device.

13. Laboratory automation system according to claim 12,
wherein the laboratory sample container carrier comprises at least one magnetically active device, in particular at least one permanent magnet, and
wherein the drive means comprise a number of electro-magnetic actuators being stationary arranged in rows and columns below the transport plane, wherein the electro-magnetic actuators are adapted to apply a magnetic force to the laboratory sample container carrier.

14. Laboratory automation system according to claim 10, wherein the laboratory automation system comprises:
at least one pre-analytical, analytical and/or post-analytical laboratory apparatus, wherein the laboratory apparatus is adapted to interact with the laboratory sample container carrier, a laboratory sample container carried by the laboratory sample container carrier, and/or a laboratory sample contained by the laboratory sample container supplied to the revolving device.

15. Use of the laboratory sample container handling apparatus according to claim 1 for handling the laboratory sample container carrier in a laboratory automation system.
